(19) United States
(12) Patent Application Publication
(10) Pub. No.: US 2022/0070517 A1
(43) Pub. Date: Mar. 3, 2022

(54) SYSTEM AND METHOD FOR SIMULTANEOUS DISTRIBUTION OF PERSONALIZED CONTENT TO MULTIPLE USERS

(71) Applicant: Rivu, Inc., Bedford Hills, NY (US)

(72) Inventors: Jordan Hirsh, New York, NY (US); Carlos Rivera, Jackson Heights, NY (US)

(21) Appl. No.: 17/343,702

(22) Filed: Jun. 9, 2021

Related U.S. Application Data
(60) Provisional application No. 63/071,645, filed on Aug. 28, 2020.

(51) Int. Cl. H04N 21/258; H04N 21/2187; H04N 21/81; H04N 21/234; H04N 21/25; G06N 20/00

(52) U.S. Cl. CPC H04N 21/25891; H04N 21/2187; G06N 20/00; H04N 21/23424; H04N 21/251; H04N 21/812

(57) ABSTRACT

A live-radio streaming system for distribution of personalized commercial content packages to multiple users simultaneously. The system having a listener portal, a broadcaster portal, and an advertiser portal. The listener portal featuring user profiles comprising private brand interest profiles for storing personal interest information. The broadcaster portal allowing a broadcaster to distribute live audio feeds, create commercial content packages, and push personalized commercial content packages to multiple listeners simultaneously. The advertiser portal allowing an advertiser to create commercial content packages.

### CROSS REFERENCE TO RELATED APPLICATIONS

This application claims the benefit of U.S. Provisional Patent Application No. 63/071,645 filed Aug. 28, 2020, which is incorporated by reference herein in its entirety.

### BACKGROUND

### Field of Invention

The present invention relates generally to content distribution systems, and more specifically, to an interactive live radio streaming system for providing personalized interest-based advertising content to multiple users simultaneously.

### Related Art

Currently, live radio applications generate revenue mainly through advertising and sponsorship. However, these live radio applications are fraught with unengaging commercials resulting in majority of listeners changing stations several times during listening session. Many of these applications also provide a subscription option where listeners may stream commercial-free live radio for a fee. This commercial-free streaming provided by the live radio applications is generally limited to the applications' display commercials as there is typically no control over the commercials played by the broadcasters. Further, while this commercial-free subscription option is beneficial for the listener and provides revenue for the owner of the application, the revenue that an application can generate through selling commercial space is generally more than that which it can generate though a commercial-free subscription model.

What is needed is an interactive live radio streaming system allowing for the distribution of personalized interest-based advertising content to multiple listeners simultaneously, and allowing listeners to shop advertised content within the application. This will ultimately increase the return on investment for advertisers as their commercials reach more engaged and interested listeners and increase conversions from said commercials as listeners are able to immediately make purchases of the advertised content directly within the application.

### SUMMARY OF INVENTION

The present invention is directed to a live radio streaming system which includes a content distribution system for distribution of personalized commercial content packages to multiple users simultaneously. The live radio streaming system having a listener portal, a broadcaster portal, and an advertiser portal. The listener portal featuring user profiles comprising private brand interest profiles for storing personal interest information. The broadcaster portal allowing a broadcaster to distribute live audio feeds, create commercial content packages, and push personalized commercial content packages to multiple listeners simultaneously. The advertiser portal allowing an advertiser to create commercial content packages.

These and other features of the present invention will become readily apparent upon further review of the specification and drawings.

### BRIEF DESCRIPTION OF THE DRAWINGS

Embodiments of the present invention will be described by way of example only, and not limitation, with reference to the accompanying drawings.

FIG. 1 shows an exemplary environment in which the invention may be implemented;

FIGS. 2a through 2d show exemplary preset menu screens within the application prompting a listener to enter personal interest information according to an embodiment of the present invention;

FIGS. 3a and 3b show exemplary commercial packages displayed to a listener within the application:

FIGS. 4a and 4b show exemplary listener screens showing commercials saved for later viewing; and

FIG. 5 shows an exemplary template of a key performance indicator screen for the advertiser or broadcaster portal.

### DETAILED DESCRIPTION

It is to be understood that the phraseology and terminology employed herein are for the purpose of description and should not be regarded as limiting.

The present invention discloses a live radio streaming system which incorporates a commercial content distribution system and method for simultaneous distribution of personalized content to multiple users, the live radio streaming system accessible to users through a downloadable software application, a non-downloadable web-based application, a webpage accessible via a web browser, or through other means commonly known for accessing live-radio streaming systems. The end users of the live radio streaming system are listeners, advertisers, and broadcasters each of whom are required to create a user profile in order to use the system. Listeners access the system for entertainment purposes to stream live content and shop advertised content. Advertisers access the system to promote their goods and services by way of commercial content packages pushed to listeners. Broadcasters access the system to manage live streaming content and commercial content packages pushed to listeners.

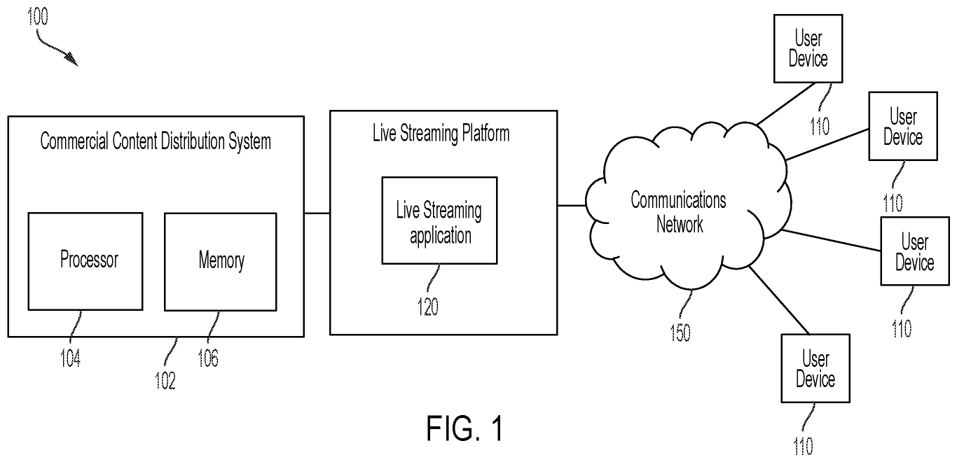

FIG. 1 illustrates an exemplary environment 100 in which the invention may be implemented. The environment 100 may include a commercial content distribution system 102, a plurality of user devices 110 (including listener devices, broadcaster devices and advertiser devices), and an interactive live-radio software application 120. User devices may be mobile computing devices, desktop computing devices, or other computing devices on which a live radio streaming application may be accessible. All of these components may be disposed in communication with one another via an electronic network, such as the Internet 150 and/or other communication networks known in the art. The number and orientation of these components may be modified. The commercial content distribution system 102 may be configured to generate and manage live-streaming of content in the interactive live-radio application 120 for display on user devices 110. The interactive live-radio application 120 may be accessible on a user device 1I0 by way of a downloadable application installed on the user device, non-downloadable application accessible on the user device, or by way of a webpage accessible via a web browser accessed on the user device. The commercial content distribution system 102 may include a processor 104 and a memory 106. Memory 106 may store a set of programmable instructions that are executable by processor 104 to enable the operations of the commercial content distribution system 102, as disclosed herein. Additionally, memory 106 may be used for recording or otherwise storing live feeds and advertising content saved by listeners, as disclosed herein.

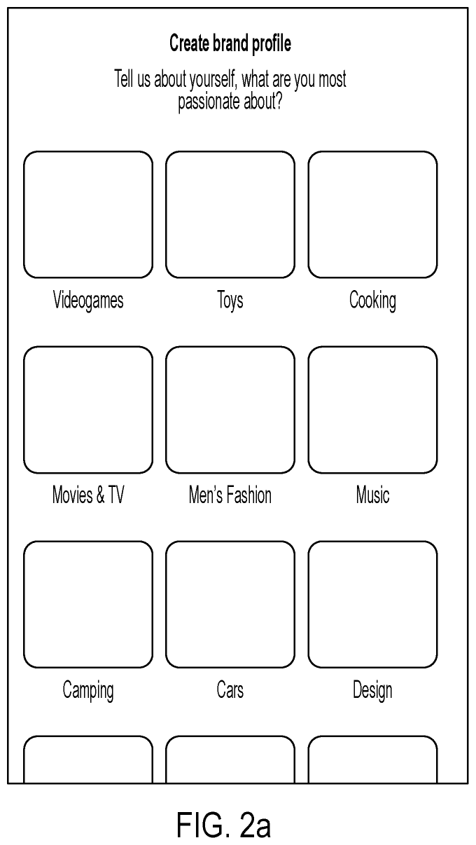

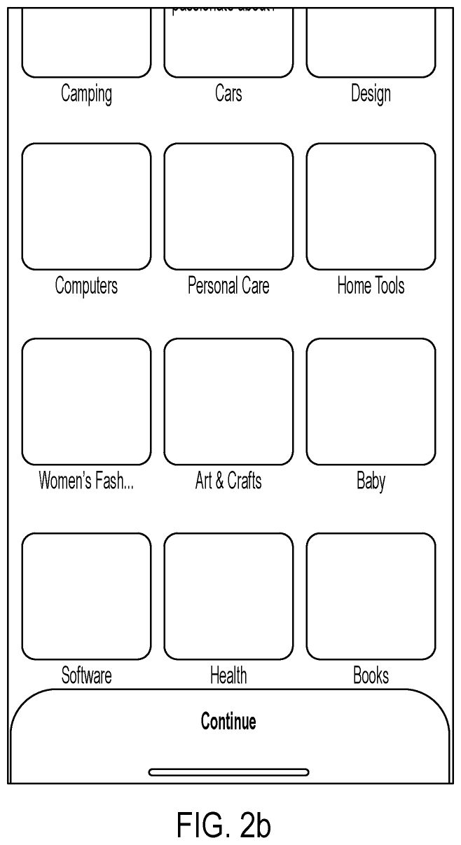

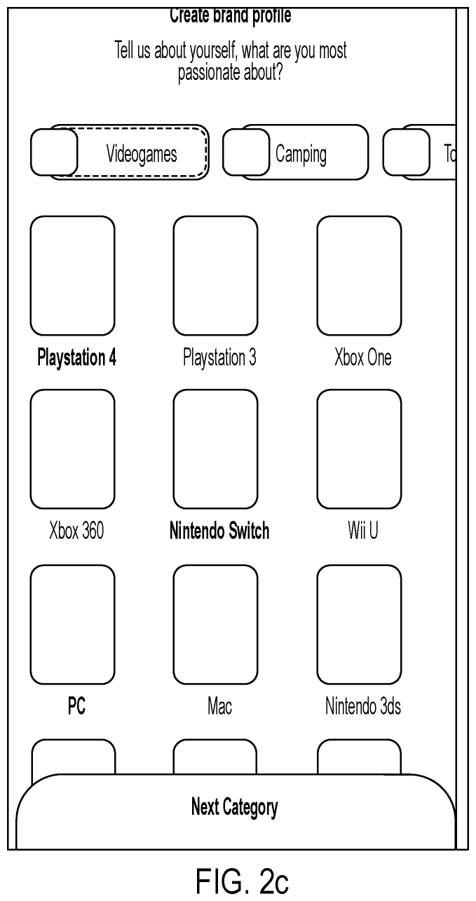

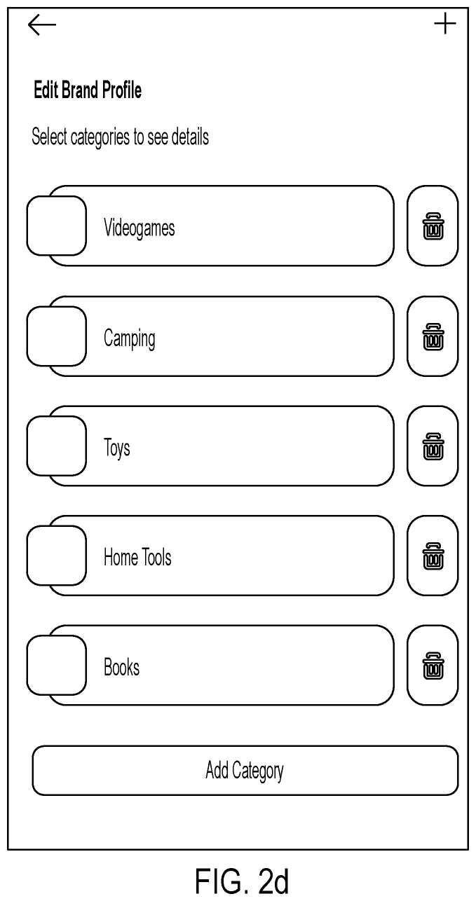

In a preferred embodiment of the present invention a listener accesses the system and method by way of a downloadable application 120 on a listener's device 110. When a listener accesses the system and method for the first time, they are prompted via listener screens to provide information related to their personal interests. This personal interest information is used to create a private brand interest profile for the listener. This personal interest information preferably provided by the listener through selection of their interests from a preset menu of interest categories and subcategories. An example of a category that the listener may select is restaurants. Within that category the listener may select the subcategory of Italian restaurants. FIGS. 2a through 2d show exemplary preset menu screens within the application prompting a listener to enter personal interest information. This personal interest information may also be provided as responses to a plurality of preset interest-based questions, or through other means generally known in the art. Each category and subcategory assigned to a user's private brand interest profile are stored as an interest tag. In the restaurant example above, the relevant interest tags may be #restaurants and #italianrestaurants.

The listener may update the personal interest information in their brand interest profile at any time. Any updates to a brand interest profile will affect the types of commercial content packages pushed to the listener. Listeners' brand interest profiles are stored in one or more databases. Interest tags are also stored in one or more databases. The one or more databases may include on-site databases, cloud databases, or a combination thereof.

Advertisers access an advertiser portal on a web-based version of the application 120 on the advertisers' devices 110. When an advertiser accesses the application for the first time, they are prompted to create an advertiser profile allowing them to use the advertiser portal to upload, edit, and share commercial content packages with broadcasters. Within the advertiser portal, advertisers may manually apply one or more pre-set interest tags to each commercial. For example, a commercial for a Ford® automobile may be tagged with #cars, #trucks, #roadtrip, #AmericanMade. This commercial may be relevant to a listener who selected “Cars” as an interest category. In an embodiment of the present invention, advertisers are unable to activate or deactivate commercial content packages once shared with broadcasters but may track certain metrics to determine the success of a commercial, allowing them to re-tag or edit the commercials accordingly. Each commercial content package, as viewed from the listener's perspective, comprises of a single commercial along with price listings and links to purchase advertised goods or services.

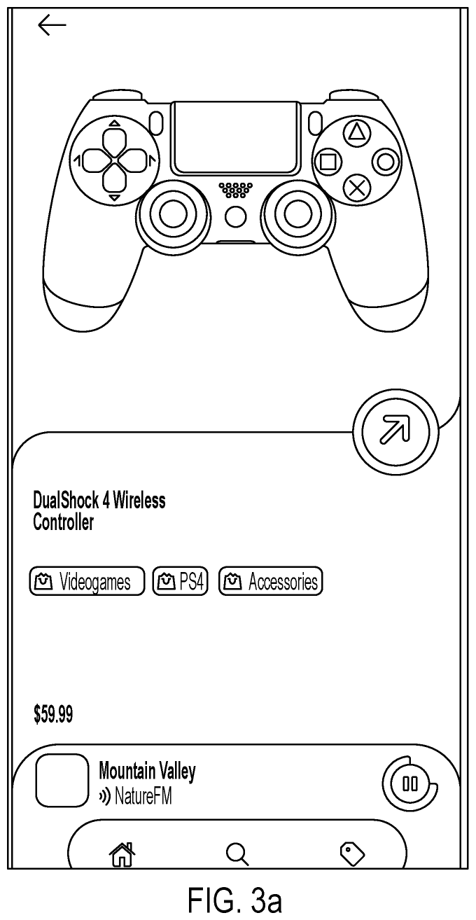

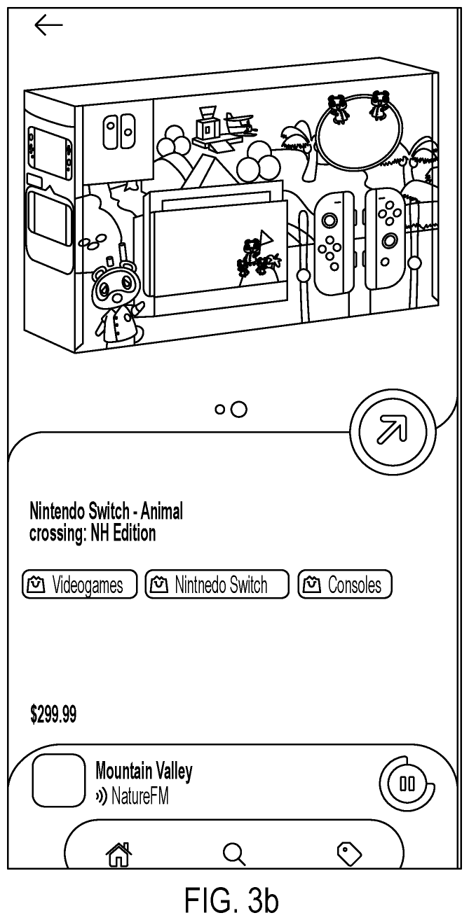

Broadcasters access a broadcaster portal on a web-based version of the application 120 on the broadcasters' devices 110. When a broadcaster accesses the application 120 for the first time, they are prompted to create a broadcaster profile allowing them to use the broadcaster portal to manage live radio feeds and commercial content packages. Within the broadcaster portal, a broadcaster may upload and manage live radio feeds, manage live user ratings, upload, edit, activate, and deactivate commercial content packages, and manually build commercial content packages with audio and/or video files, images, price listings, links to purchase, and commercial duration codes to be pushed to listeners. FIGS. 3a and 3b show exemplary commercial content packages displayed to a listener within the application. A broadcaster may also manually tag commercials with pre-set interest tags. In an embodiment of the present invention commercials are automatically tagged with interest tags upon package creation by means of a machine learning algorithm using historical data to predict the relevant interest tags. By way of the same machine learning algorithm, interest tags may be displayed automatically as suggestions for an advertiser's or broadcaster's approval and application to commercials using historical data to make interest tag suggestions.

A commercial content distribution system 102 operating within the live radio streaming application automatically distributes commercial content packages to each listener during a commercial break based on the interest tags assigned to the commercials and to the listeners. The commercial content distribution system 102 further having a content distribution algorithm stored on a server for dynamically inserting commercial content packages into live audio feeds allowing one or more commercial content packages to fit perfectly within the commercial breaks experienced by each individual listener. By way of example only, a listener may experience a commercial break period lasting two minutes. Commercial content packages are assigned to listeners by the content distribution algorithm by matching the pre-set interest tags stored in the listeners' profiles to pre-set interest tags assigned to the commercials within the commercial content packages. Commercial content packages may be assigned to listeners upon assignment of an interest tag to the listener's brand interest profile or upon creation of a commercial content package. The content distribution algorithm selects one or more commercial content packages to display to that listener based on that two-minute commercial break period and based on the commercial content packages assigned to a user. Multiple listeners of the same radio station within the application may hear and view different commercial content packages during that two-minute commercial break period depending on the information in their brand interest profile. Listeners are able to view advertised content within the application while a commercial airs.

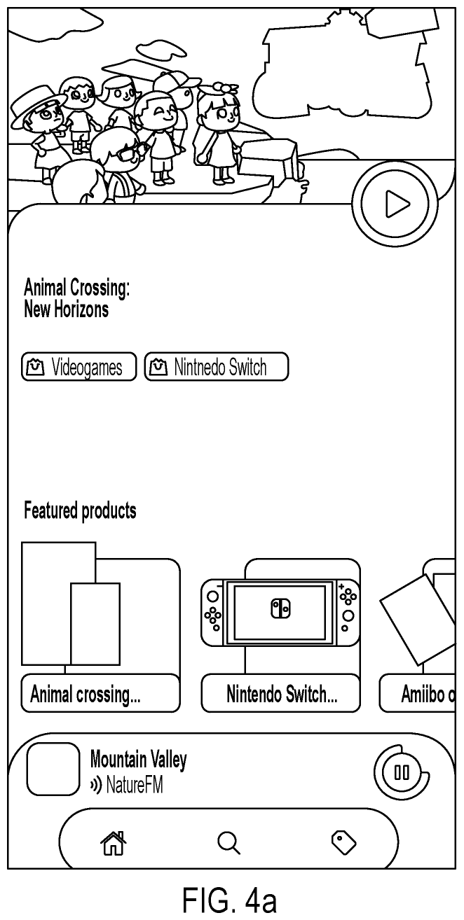

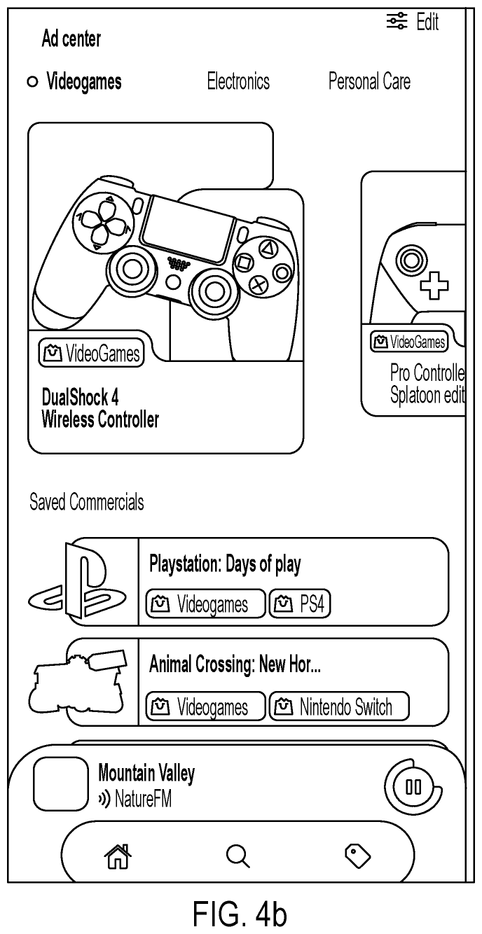

A listener viewing advertised content may save said advertised content in their user account for future viewing and interaction. The listener may save an entire live streaming session comprising of a certain length of airplay or a user may opt to only save specific advertised content aired within a live session. FIGS. 4a and 4b are exemplary listener screens showing commercial packages saved for later viewing. A listener may purchase a product or service featured in a commercial content package, directly within the application. Purchases of advertised product may be made entirely within the application or through links within a commercial content package directing the user to an in-application browser displaying an external product page. In an embodiment of the present invention, upon placing an order, the listener may track their purchase and the delivery of such within the application. The listener may store payment and shipment information within their user profile so that purchases may be made through pressing a single button.

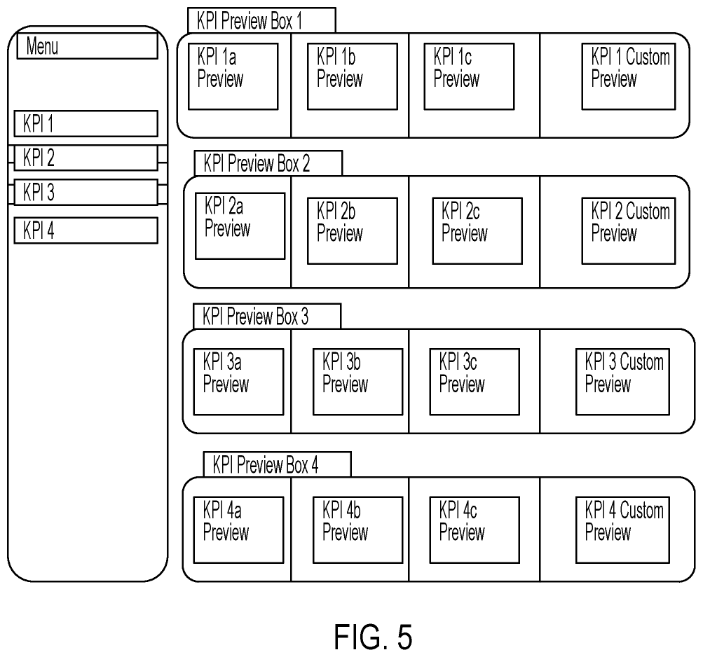

In addition to the features identified above, the advertiser and broadcaster portals allow users to view certain key performance indicators relating to listener ratings and commercial performance. Examples of key performance indicators may be total number of listeners within a certain time period or interest category, total number of commercials distributed within a certain time period, and total commercial revenue generated. FIG. 5 shows an exemplary template of a key performance indicator screen for the advertiser or broadcaster portal.

The present invention includes software which may either be loaded onto a computer or accessed by a computer. The loaded software may include an application on a smart device. A computer may access the software via a web browser using the internet, extranet, intranet, host server, internet cloud and the like.

It should be understood that the foregoing relates to exemplary embodiments of the invention and that modifications may be made without departing from the spirit and scope of the invention.

What is claimed is:

1. A live radio streaming system for distribution of personalized commercial content packages to multiple users simultaneously, the system comprising:
a commercial content distribution system comprising a processor and a memory;
a listener portal comprising a user profile, said user profile comprising a brand interest profile storing personal interest information wherein said personal interest information is stored in one or more databases as interest tags;
a broadcaster portal comprising means for distributing live audio feeds, means for creating commercial content packages, and means for tagging said commercial content packages with duration codes and interest tags; and
an advertiser portal comprising a means for creating commercial content packages and tagging said commercial content packages with interest tags.

2. The system of claim 1, wherein the brand interest profile is private.

3. The system of claim 1, wherein the duration codes are applied to commercial content packages automatically by a content distribution algorithm.

4. The system of claim 1, wherein interest tags are provided as suggestions by way of a machine learning algorithm, to be manually approved by a broadcaster or advertiser for application to commercial content packages.

5. A method for the simultaneous distribution of personalized commercial content to multiple listeners by way of a commercial content distribution system, the method comprising:
selecting the commercial content distribution system of claim 1;
assigning commercial content packages to listeners by matching pre-set interest tags stored in the listeners' profiles to pre-set interest tags assigned to commercials within the commercial content packages;
determining, during a live stream of audio content, a commercial break period for an upcoming commercial break in said live stream;
for each listener, based on the length the commercial break period, selecting one or more commercial content packages assigned to said listener wherein the total length of said one or more commercial content packages is equal to said commercial break period;
distributing said selected one or more commercial content packages to each listener during the commercial break period.

6. The method of claim 5, wherein the commercial content packages are distributed to each listener in the form of audio-visual content displayed within a live radio streaming application operating on a listener's device.

7. The method of claim 5, wherein the commercial content packages are distributed to each listener in the form of visual content displayed within a live radio streaming application operating on a listener's device.
